(19) United States
(12) Patent Application Publication
(10) Pub. No.: US 2015/0254691 A1
(43) Pub. Date: Sep. 10, 2015

(54) SYSTEM AND METHOD OF CONSTRUCTING ON-LINE SURVEYS

(71) Applicant: TWIST OF LEMON PTY LTD, Melbourne, Victoria (AU)

(72) Inventors: Garreth John Chandler, Ballarat (AU); Shane Stewart Hall, Mont Albert (AU)

(21) Appl. No.: 14/423,283

(22) PCT Filed: Aug. 23, 2013
(86) PCT No.: PCT/AU2013/000936

§ 371 Date: Feb. 23, 2015

(30) Foreign Application Priority Data
Aug. 23, 2012 (AU) 2012903636

(51) Int. Cl. G06Q 30/02; G06F 3/0482; G06F 3/0484

(52) U.S. Cl. CPC G06Q 30/0203; G06F 3/04842; G06F 3/0482

(57) ABSTRACT

A system and method of constructing on-line surveys is provided. In particular, the system and method assist a survey user in the construction of an on-line survey in that a graphical interface is presented to the user that includes graphical objects representing question types and/or formats, and the user is enabled to select graphical objects and to place the graphical objects representing pre-established survey components in a sequence, thereby defining a sequence of steps in an on-line survey. The sequence is further displayed to the user on the graphical interface, and once finalized, translated into computer readable format and deployed on-line to survey participants.

### FIELD OF THE INVENTION

This invention relates to a system and method of constructing on-line surveys.

### BACKGROUND OF THE INVENTION

A survey provides one technique by which specific and targeted feedback may be obtained from a population of individuals or groups. Generally, a survey comprises multiple question types which may be presented in a range of formats and the primary objective when constructing a survey is to obtain meaningful data on behalf of the recipient of the survey data, namely, the “survey user”.

To obtain meaningful information from a survey, it is important that question types and the format of the survey are such that the survey can be understood by survey participants, there are good prospects that a survey participant will complete the survey (e.g. it is not too long), the survey progresses in a logical and meaningful manner, and a completed survey provides the survey user with data that can be interpreted in a meaningful way.

Whilst there are a large number of alternative arrangements for formatting a survey, formatting a survey to meet the above and other important requirements generally requires a significant degree of skill and experience. Since many survey users lack the requisite degree of skill and experience necessary, it is therefore often necessary for survey users to engage the services of a survey developer. However, engaging the services of a specialist often significantly increases the time required to develop a survey and the expense associated therewith.

With the increasing use of computers and on-line technologies, there has been a trend to replace paper based and telephone survey methods with on-line survey formats thereby avoiding the need for collection and compilation of survey results. For large surveys involving a significant population of survey participants, recording survey results usually required the use of automated compilation machines for the purpose of translating and analyzing the survey data that was entered manually.

On-line surveys provide a more convenient method to distribute surveys to a large number of users and by collecting survey data electronically, the compilation and analysis of survey results is significantly improved both in relation to the amount of time taken to conduct the analysis and the cost associated with same.

However, whilst there are significant benefits to the distribution and collection of surveys by a computer and/or on-line means, an unfortunate negative consequence is the increased complexity with respect to the requirement to script, code and/or compile a survey that is presented to a survey participant into a computer readable format.

Accordingly, it is often necessary for survey users to engage or employ a third party having the requisite level of technical skill necessary to script, code and/or compile the survey into a computer readable and/or on-line format. The additional requirement to engage the services of a specialist to script, code and/or compile a survey into a computer readable format also significantly increases the time associated with the compilation, development and deployment of an on-line survey and the expense associated therewith.

As a result, there is a need to assist survey users in the preparation, development and deployment of on-line surveys that assist the survey user to achieve the important goals described above.

Any discussions of documents, acts, materials, devices, articles or the like, which has been included in the present specification is solely for the purpose of providing a context for the present invention. It should not be taken as an admission that any or all of the previous discussion forms part of the prior art base or was common general knowledge in the field of the invention as it existed before the priority date or any of the claims herein.

### SUMMARY OF THE INVENTION

In one aspect, the present invention provides a method of assisting a user to construct an on-line survey including presenting a graphical interface to the user that includes graphical objects representing pre-established survey components, the graphical objects representing question types and/or formats, enabling the user to select graphical objects and to place the graphical objects representing pre-established survey components in a sequence, thereby defining a sequence of steps in an on-line survey, and displaying the sequence of graphical objects to the user on the graphical interface.

In another aspect, the present invention provides a computer system that assists users to construct an on-line survey including a processor executing computer instruction code to present a graphical interface to the user that includes graphical objects representing pre-established survey components, the graphical objects representing question types and/or formats, enable the user to select graphical objects and to place the graphical objects representing pre-established survey components in a sequence, thereby defining a sequence of steps in an on-line survey, and display the sequence of graphical objects to the user on the graphical interface.

The selection of graphical objects representing survey components and the arrangement of same to form an appropriate sequence, effectively forms a graphical representation of a flow chart that represents the possible paths that a survey participant may take when responding to the survey questions and progressing through each question as they complete the survey. The representation of the survey components in a graphical form substantially assists a survey user to quickly identify those aspects of their proposed survey that will present problems to a survey participant. Further, providing a graphical representation of a proposed survey to a survey user also enables the survey user to quickly and easily identify those aspects of the survey that will likely present a survey participant with a path to completion of the survey that is too long and hence reduces the prospect of the participant completing the survey.

Further, presenting a survey user with pre-established graphical objects representing questions and/or formats that may be selected for placement in a preferred sequence during the development of a survey, essentially assists survey users who are not skilled computer program developers, to develop and prepare surveys for deployment, including on-line deployment, without requiring the survey users to either develop the necessary computer skills or to engage the services of a computer programming specialist to script and code the elements of the survey such that the survey may be translated into computer readable format and deploy on-line to a population of potential survey participants.

The preparation and development of a computer flow chart representing an on-line survey with the use of a computer reduces the task of automated translation of the flow chart including question types and/or formats into a computer-readable format for on-line deployment to a relatively straight forward process. In an embodiment, on completion of the development of an on-line survey, a survey user initiates a function that causes a processor to execute computer instruction code to translate the graphical flow chart representation of the on-line survey into computer instruction code for on-line deployment and execution by survey participants for the purpose of initiating and completing the on-line survey.

In another embodiment, a set of question types are represented as “shapes” and are located in a first portion of a graphical interface presented to a user. In this embodiment, each question type is presented to the user as a different shape thereby allowing the survey user to more easily identify each question type. Each shape determines the type of question in the survey and hence the type of data collected in a response to this question in the survey. Question types include a single response, multiple response, single open-ended question, multiple open-ended question, a ranked question a grid and a skip type question. Of course, any number of question types may be included with each question type being associated with any one or more shapes thereby representing the graphical objects presented to a survey user. As will also be recognized by a skilled reader, in addition to the shape of an object differentiating one question type from another, embodiments of the invention may also use other visual identity cues including colours, numbers, textures, animation or any other graphical representation that assists a user to differentiate one question type from another. Such visual identity cues may also be used to differentiate functions associated with question types, for example, loops quotas and branching.

In an embodiment, the graphical interface presented to the user includes a second portion that is initially blank where objects selected from the first portion may be selected and a copy of the graphical object may be copied into the second portion of the graphical interface. In this embodiment of the invention, the graphical objects may be selected and “dragged and dropped” into the second portion of the graphical interface thereby representing the selection and placement of the graphical object from the first portion of the graphical interface into the second portion of the interface which effectively represents the portion of the graphical interface in which the survey user develops an on-line survey. Repeated selection and copying of graphical objects from the first portion of the interface to the second portion of the interface enables the survey user to select and include in an on-line survey all of the question types required.

In an embodiment, the survey user may amend the specific question text for a question type in the second portion of the graphical interface such that the amended graphical object now represents the actual question the survey user proposes to present to a survey participant. The survey user may also amend specific question functions for a question type in the second portion of the graphical interface such that the amended graphical object also represents the function the survey user proposes to affect a survey participant's use of the survey.

In yet another embodiment, the graphical objects that are copied into the second portion of the graphical interface may be re-arranged to form a sequence with further graphical objects in the form of “connecting lines” representing the allowable paths and sequences of questions through the survey. In this embodiment, the user is enabled by the computer system to “drag and drop” graphical objects in the second portion of the graphical interface thereby enabling the user to quickly and easily establish a sequence of questions and the flow of questions that will be presented to a survey participant. In an embodiment, the sequence includes a single path flow. In another embodiment, the sequence includes several paths or branches. In yet another embodiment, the sequence includes a combination of single and multiple paths flows. These paths and sequences may run in parallel or be recursive, and may be marked by a start and end of a process.

In another embodiment, the user is presented with a set of configurable settings that are specific to each object type which allows the survey user to determine how the specific question type is presented to a survey participant. In an embodiment, the graphical interface includes a third portion that presents the survey user with the configurable settings (including but not limited to variable name, variable label, question text, answers) associated, with each specific question type.

In yet another embodiment, the graphical interface includes a “document view” which enables the user to view a created or predefined survey in logic rather than graphically. This logic may be automatically transformed by the processor into the associated object types that the survey user can further modify and change. In an embodiment, predefined or specific survey formats may be selected and presented to the user for use or further modification.

### BRIEF DESCRIPTION OF THE DRAWINGS

The present invention will now be described with reference to the accompanying drawings which illustrate exemplary embodiments of the present invention, wherein:

FIG. 1 is a diagrammatic representation of an embodiment of a graphical interface presented to a survey user detailing a first portion of the interface;

FIG. 2 is a diagrammatic representation of an embodiment of the graphical interface detailing the user selection with a function;

FIG. 3 is a diagrammatic representation of an embodiment of a graphical interface presented to a user detailing placements of graphical objects in a second portion of the graphical interface;

FIG. 4 is a diagrammatic representation of a graphical interface according to an embodiment of the invention detailing a third portion of the graphical interface and the functional assistance provided to a survey user to select the configuration of an object type; and

FIG. 5 is a diagrammatic representation of a graphical interface according to an embodiment of the invention in which the second portion of the graphical interface is used to present a document view to a survey user detailing logic associated with object types.

### DETAILED DESCRIPTION OF EMBODIMENT(s) OF THE INVENTION

Embodiments of the invention are now described with reference to the accompanying figures which provide diagrammatic illustrations of a graphical interface presented to a user during a process of the survey user preparing and developing an on-line survey.

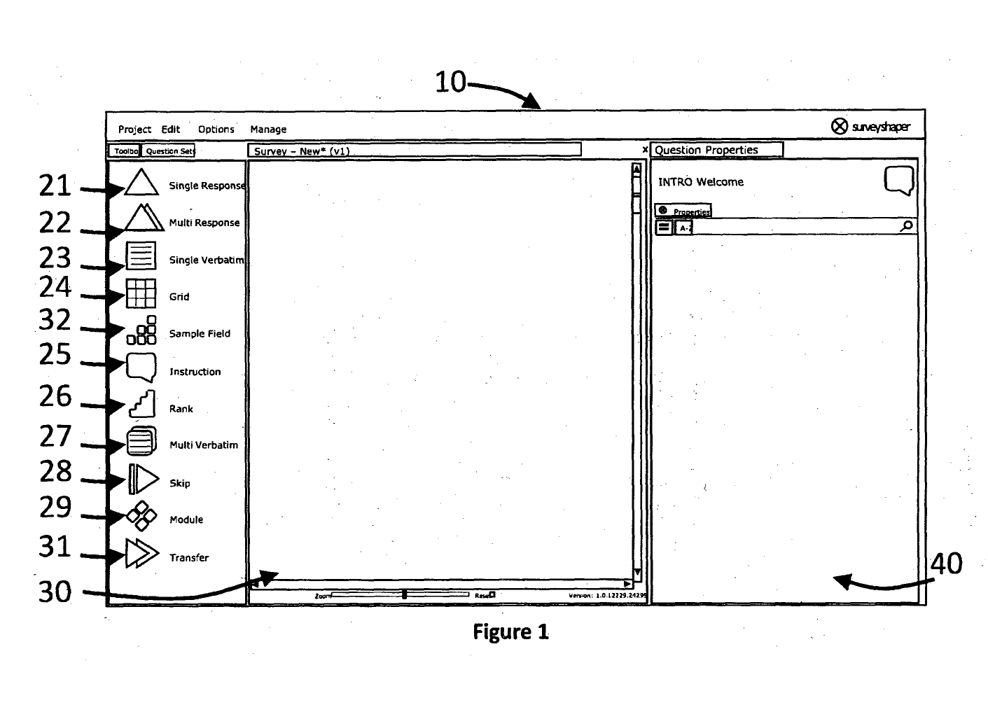

With reference to FIG. 1, a graphical interface (10) is presented to a survey user and includes a first portion (20) that displays objects, a second portion (30) in which the survey, user may form a sequence of questions and a third portion (40) that displays a range of configuration settings that may be selected by a survey user.

In the first portion (20) of the graphical interface (10), a number of objects are displayed (21 to 29) with each graphical object representing a question type and/or format. For example, the single response graphical object (21) is an object representing a question for which only a single response may be provided. Similarly, the multi response graphical object (22) represents a question type for which multiple responses may be provided.

The table below details a range of examples of question types with a brief explanation of each example.

| Question | |
|---|---|
| Type | Explanation |
| Single | An interface that allows the survey participant |
| Response | to enter/select one answer for that question. |
| | The value is typically numerical in value rather |
| | than string/text |
| Multi | An interface that allows the survey participant |
| Response | to enter/select one or more answers for that |
| | question. |
| | The value is typically numerical in value rather |
| | than string/text. |
| Single | An interface that allows the survey participant |
| Verbatim | to enter one answer for that question. |
| | The value is typically string/text rather than |
| | numerical in value. |
| Grid | An interface that presents multiple questions (or |
| | sub-questions) sharing the same answer |
| | options as a set. This can be presented as both |
| | a single response question type or as a multiple |
| | response question. |
| | The value is typically numerical in value rather |
| | than string/text. |
| Instruction | An interface that presents information |
| | on-screen without requiring the survey |
| | participant to enter information. |
| Rank | An interface that allows the survey participant |
| | to position and rank two or more items relative |
| | to other items shown on screen. |
| Multi | An interface that allows the survey participant |
| Verbatim | to enter one or more answers for that question. |
| | The value is typically string/text rather than |
| | numerical in value. |
| Skip | A hidden object (i.e. not seen by the survey |
| | participant). The function of this object is to |
| | route the respondent to parts of the survey |
| | deemed by the scripter to be relevant to the |
| | survey participant based on their responses. |
| Module | An object that allows additional questions to be |
| | dropped in, and taken out of, the flow of the |
| | survey in a manner that allows for version |
| | control. This would be used predominantly in |
| | tracking, or on-going, surveys with a core |
| | component and a separate ad-hoc component |
| | that changes regularly (eg. Weekly, fortnightly, |
| | monthly, quarterly, etc). |
| | A module object is linked with a module project |
| | containing additional questions. |
| Sample | An object that allows information related to the |
| Field | target survey participant (e.g. location or |
| | segment) to be uploaded and used as part of |
| | the survey flow. In order for sample items to be |
| | applied and used successfully in the survey |
| | flow, each survey participant would have to be |
| | assigned a unique URL. |
| | This object can be hidden or un-hidden. The |
| | value can be string/text or numerical, |
| | depending on the type of information uploaded. |
| Transfer | A hidden object that routes the survey |
| | participant to another URL (as opposed to |
| | another part of the survey; see Skip). |
| | Applications could include routing at the end of |
| | the survey (e.g. back to the website of the |
| | survey sponsor) or routing in the middle of the |
| | survey (e.g. survey participant starts the survey |
| | by going to StoreTypeA.com.au but, based on |
| | their responses, are routed to |
| | StoreTypeB.com.au so that the URL of the |
| | survey and the branding of the survey are |
| | consistent). |
| Branch | An object that identified parallel paths that a |
| | survey user may encounter. This function is |
| | used to organize a large or complex survey into |
| | individual flow paths, and allows the survey |
| | user to more easily view the flow of the survey |
| | and identify the logical paths that a survey |
| | participant will be subject to. |

Each question type may be associated with one or more question formats such as those identified below.

| | |
|---|---|
| Question | |
| Format | Explanation |

Single response

| | |
|---|---|
| Vertical | Radio buttons presented in a vertical layout |
| Radio | on-screen. Defaults to one column. |
| Horizontal | Buttons presented in a horizontal layout |
| Radio | on-screen, with the answer label presented in the |
| | same container as the selector. |
| Rating | Buttons presented in a horizontal layout |
| | on-screen, with the answer label presented on top |
| | of the selector. |
| Slider | Horizontal layout with a bubble/selector that |
| | runs along the slider. |
| Heat | Coloured buttons presented in a horizontal |
| Rating | layout on-screen, with the answer label |
| | presented in the same container as the |
| | selector. |
| Drop Down | A series of answers presented in a drop down |
| | box. |
| Date | DD, MM, YYYY drop down boxes |
| DropDown | |
| Date Picker | DD, MM, YYYY date picker using a calendar |
| Time Picker | HH, MM, SS picker using a time picker |
| Time Entry | HH, MM text boxes |
| Time | HH, MM drop down boxes |
| DropDown | |
| Numerical | Text box with a number-stepper to enter |
| | numbers |
| DateTime | DD, MM, YYYY, HH, MM drop down boxes |
| DropDown | |
| Map | Radio buttons overlayed with graphical |
| | representation of an area (map). Survey users |
| | click on the different parts of the map to |
| | nominate an answer. |
| Image | Picture presented in a horizontal layout on the |
| | graphical interface. The data stored is the |
| | label/text or an answer rather than the picture. |

Multi response

| | |
|---|---|
| Checkbox | Check boxes presented in a vertical layout |
| | on-screen. Defaults to one column. |
| Image | Pictures presented in a horizontal layout |
| | on-screen. The data stored is the label/text or an |
| | answer rather than the picture. |

Single verbatim

| | |
|---|---|
| Verbatim | A single text box for entering alphanumeric |
| | values unless otherwise specified |

Grid

| | |
|---|---|
| Horizontal | A grid presented as radio buttons (a single |
| Radio Grid | response or column for each sub-question or |
| | row) |
| Vertical | A grid presented as radio buttons (a single |
| Radio Grid | response or row for each sub-question or |
| | column) |
| DropDown | A grid presented as drop downs (a single |
| Grid | response or drop down for each sub-question |
| | or row) |
| Checkbox | A grid presented as check boxes (multiple |
| Grid | responses or columns for each sub-question or |
| | row) |
| Stack | A grid presented as a single slider with each |
| Slider | sub-question or row present around (above or |
| | below) the slider where the survey user can |
| | click and drag options onto a slider. |
| Scaling | A grid presented as radio buttons (a single |
| Grid | response or row for each answer type or |
| | column) wherein responses across columns |
| | must not be on the same row. |
| Slider | A grid presented as sliders (a single response |
| Grid | or column for each sub-question or row) |

Instruction

| | |
|---|---|
| Text Only | Text-only presentation |

Rank

| | |
|---|---|
| Ranking | Answers or rankings are presented in drop |
| | down boxes, depending on user specifications. |
| | As the respondent chooses an answer/ranking, |
| | it is greyed out in subsequent options. |

Multi Verbatim

| | |
|---|---|
| Verbatim | A series of fields for entering alphanumeric |
| | values unless otherwise specified. The field |
| | appears underneath the text label specifying |
| | the purpose of the field (eg Address 1, Suburb, |
| | State). Numerical values entered are not |
| | summed. |
| Verbatim | A series of fields for entering alphanumeric |
| Grid | values unless otherwise specified are |
| | presented in a grid. The field appears to the |
| | right hand side of the text label specifying the |
| | purpose of the field (eg Address 1, Suburb, |
| | State). |
| Numerical | A series of fields for entering numerical values |
| Grid | provided in a grid. The field appears to the right |
| | hand side of the text label specifying the |
| | purpose of the field. The numerical values |
| | entered are summed automatically. |
| Numerical | A series of fields for entering numerical values. |
| | The field appears to the right hand side of the |
| | text label specifying the purpose of the field. |
| | The numerical values entered are summed |
| | automatically. |

Sample Item

| | |
|---|---|
| Numeric | Radio buttons presented in a vertical layout |
| | on-screen. Defaults to one column. |
| String | A single text box for piping alphanumeric values |
| | unless otherwise specified |

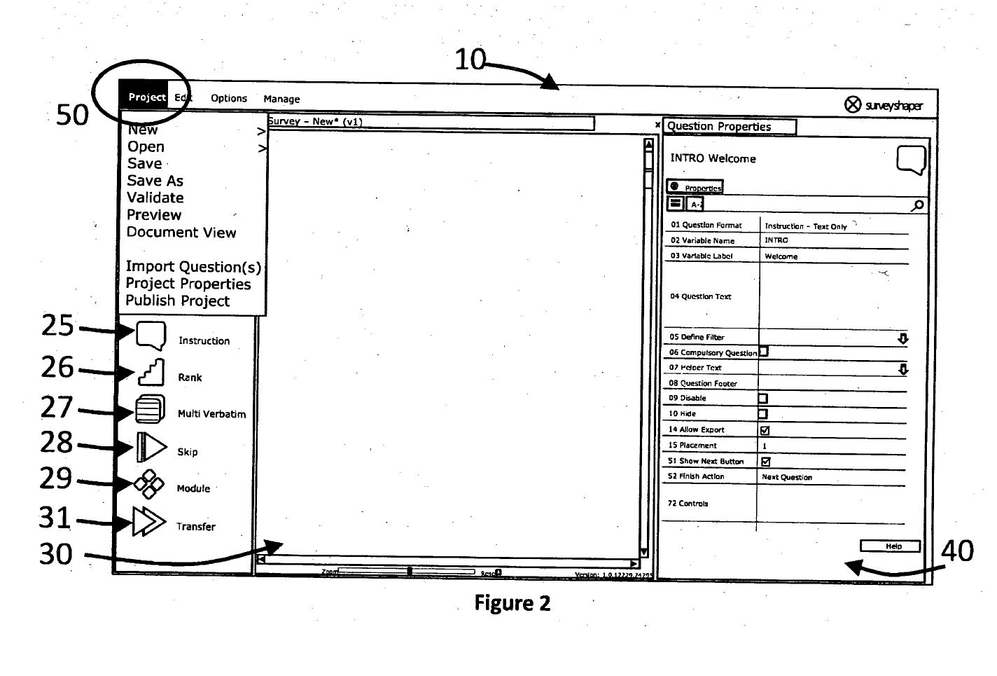

With reference to FIG. 2, to commence the process of preparing and developing an on-line survey, the survey user selects the drop down menu item (50) to display a range of sub-menu options including, but not limited to, the function to establish a new survey. Having selected the option to establish a new survey, the survey user is then able to use the second portion interface (30) to form a sequence of survey components that define an on-line survey.

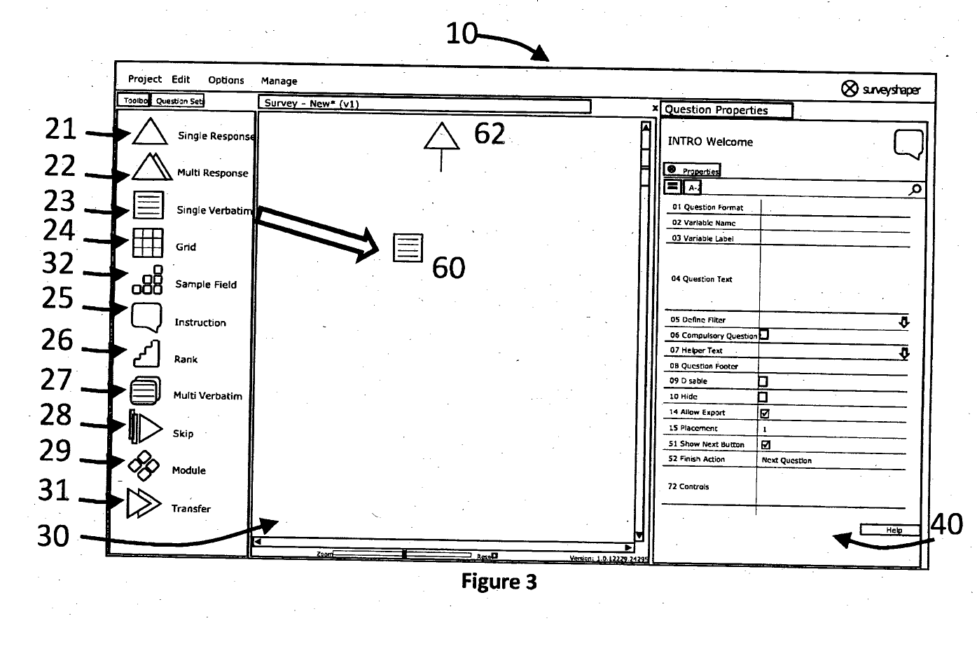

For example, with reference to FIG. 3, the user is provided with the facility to copy graphical objects representing question types and/or formats. The first portion of the graphical interface (20) and may copy graphical objects representing question types by selecting the graphical object with a pointing device and “dragging and dropping” the graphical object representing a question type from the first portion of the graphical interface (20) to the second portion of the graphical interface (30).

In the example of FIG. 3, the diagrammatic representation the graphical interface presented to the survey user details the copying of a single verbatim question type (23) from the first portion of the graphical interface (20) to the second portion of the graphical interface (30). The single verbatim question that is to form part of the on-line survey (60) appears in the portion of the graphical interface (30) in which a directed connecting link (62) has previously been created. The user may also wish to change the single verbatim question type to other question types. This can be done by right-clicking on the object and changing it to the desired type. Double-clicking the object cause a dialog box to be displayed where the user can enter information, such as the question and possible answers, that will be shown on-screen to the survey participant.

The process described above in relation to copying and editing survey components are repeated until the survey user is satisfied the on-line survey that has been developed.

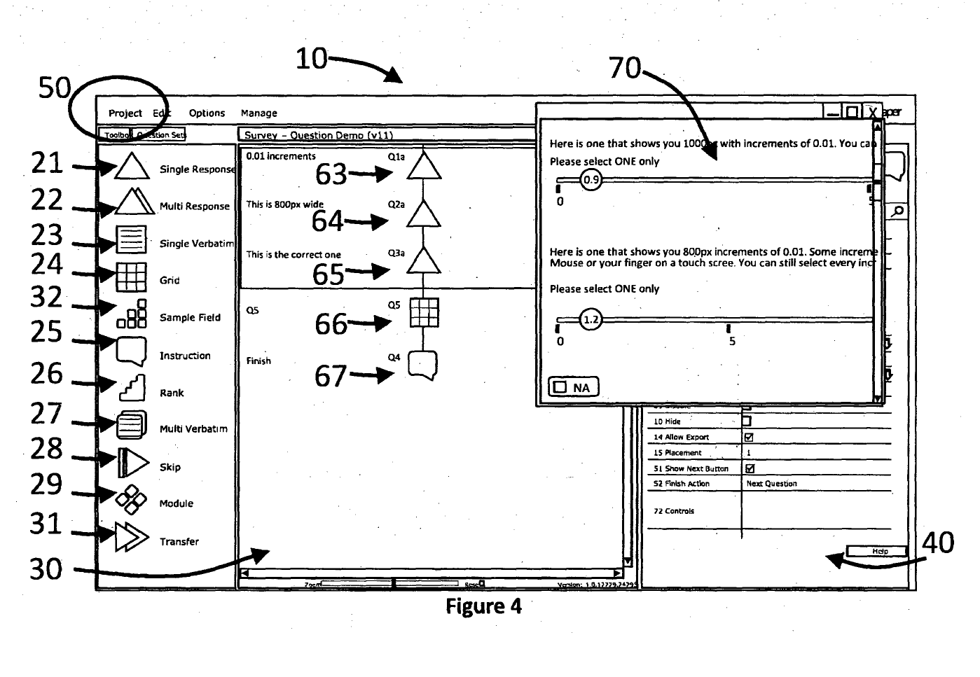

With reference to FIG. 4, a diagrammatic representation is provided of the graphical interface (10) for which a completed on-line survey has been established by a survey user, a flow-chart of the on-line survey appearing in the second portion of the graphical interface (30), in which various question types are linked and in the example of FIG. 4, a single path flow through a range of questions is displayed. In this example, the question types (63 to 67) that form the questions in the on-line survey are connected in series with one another.

At this stage, the survey user is provided with the facility to adjust a range of configurable settings with respect to each of the survey components in the on-line survey and these facilities are selected from a range of options displayed in the third portion of the graphical interface (40).

The settings that the user can configure to affect how a survey appears on screen for a survey participant to answer include, but are not limited to, the look and feel of the answers on screen including height and width of text boxes or the start position of the answer selector on sliders, randomization or rotation, answer validation and answer sequences. The settings that the user can configure, to affect how a survey question may affect the survey user include, but are not limited to, loops, quotas and branches.

FIG. 4 illustrates an example of a graphical prompt box (70) presented to a survey user after the user has clicked on an associated setting in the third portion of the graphical interface (40), prompting the user regarding the manner in which they would like a horizontal slider to appear to the survey participant.

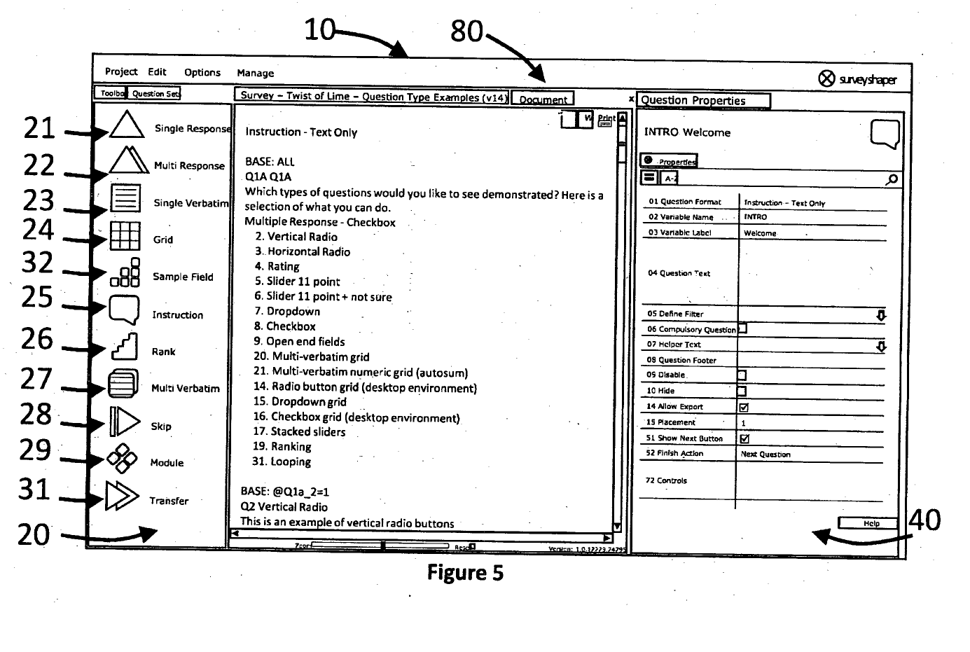

In an embodiment, the user may view the content of the second portion (30) in a “document view” format, as shown in FIG. 5. This format may be accessed by clicking the “Document” object (80) to effect “document view”. The “document view” can be selected at any time during the creation of a survey to illustrate the survey logic. In an embodiment, a user may select “document view” at the start of the survey creation process and be presented with a “skeleton” of the survey according to a predefined format which may then be modified by the user.

The computer assisted development of an on-line survey with the use of graphical objects representing discreet survey components and enabling a survey user to construct an on-line survey in a graphical format significantly assists survey users who do not possess the requisite skill and experience in the development of on-line surveys. The survey users are assisted to construct a survey that has better prospects of achieving the previously stated objectives of a survey and in particular, the development of on-line surveys that are likely to be completed by survey participants and result in meaningful data for the survey user. Further, enabling a user to develop and amend an on-line survey in a graphical form also greatly assists survey users to adapt previously developed on-line surveys to suit new circumstances without requiring the survey user to re-develop an on-line survey from the beginning.

Even further, the establishment of an on-line survey in a graphical form also enables the automated translation of the contents of the on-line survey into a computer readable format for deployment from the host development computer to a target computer platform used by a survey participant.

Further advantages and improvements may be made to the present invention without deviating from its scope. Although the invention has been shown and described in what is conceived to be the most practical embodiment, it is recognized that departures may be made therefrom within the scope and spirit of the invention, which is not to be limited to the details disclosed herein but is to be accorded the full scope of the claims so as to embrace any and all equivalent systems and methods.

Any discussion of the prior art throughout the specification should not be considered as an admission that such prior art is widely known or forms part of the common general knowledge in the relevant technical field.

Except where the context requires otherwise due to express language or necessary implication, the word “comprising” is used in the sense of “including”, i.e. the features specified may be associated with further features in various embodiments of the invention.

1. A computer-implemented method of assisting a user to construct an on-line survey including:
presenting a graphical interface to the user that includes graphical objects representing pre-established survey components, the graphical objects representing question types and/or formats;
enabling the user to select graphical objects and to place the graphical objects representing pre-established survey components in a sequence, thereby defining a sequence of steps in an on-line survey; and
displaying the sequence of graphical objects to the user on the graphical interface.

2. A computer-implemented method according to claim 1, wherein the display is in the form of a flow chart that represents possible paths that a survey participant may take when undertaking the on-line survey.

3. A computer-implemented method according to claim 1, wherein the display is in the form of logic that represents, in words, possible paths that a survey participant may take when undertaking the on-line survey, the logic being transformable into a sequence of graphical objects on the graphical interface.

4. A computer-implemented method according to claim 1, further including:
transforming, by a computer processor, a sequence of graphical objects representing a user's survey into a computer readable format.

5. A computer-implemented method according to claim 4, further including:
deploying, via a network interface, the transformed survey to one or more on-line survey participants for the purpose of initiating and completing the on-line survey.

6. A computer-implemented method according to claim 1, wherein the graphical objects are represented and distinguished by one or more visual identity cues.

7. A computer-implemented method according to claim 6, wherein said visual identity cue includes shape, colour, number, texture and/or animation.

8. A computer-implemented method according to claim 6, wherein the visual identity cues further differentiate functions associated with each question type including, but not limited to, loops, quotas and branching.

9. A computer-implemented method according to claim 1, wherein question types include, but are not limited to, a single response, multiple response, single open-ended question, multiple open-ended question, a ranked question a grid and a skip type question.

10. A computer-implemented method according to claim 1, wherein the graphical interface includes a first portion presenting said graphical objects to the user for selection.

11. A computer-implemented method according to claim 10, wherein the graphical interface includes a second portion into which said selected graphical objects are placed and represents a portion of the graphical interface in which the survey user develops the on-line survey.

12. A computer-implemented method according to claim 11, wherein said selection and placement of graphical objects includes clicking on graphical objects in the first portion, dragging the objects into the second portion, and dropping the objects into the second portion such that each object then represents an actual question in the on-line survey.

13. A computer-implemented method according to claim 12, wherein survey question text associated with each graphical object in the second portion is modifiable.

14. A computer-implemented method according to claim 12, wherein survey question functions associated with each graphical object in the second portion are modifiable.

15. A computer-implemented method according to claim 11, wherein the graphical interface includes a third portion that presents to the user a set of configurable settings specific to each object type and allows the survey user to determine and modify how the specific question type is presented to a survey participant.

16. A computer-implemented method according to claim 15, wherein the configurable settings include but are not limited to variable name, variable label, question text and answers associated with each specific question type.

17. A computer-implemented method according to claim 1, further including:
enabling the user to rearrange placed graphical objects to form a sequence with further placed graphical objects in the form of connecting lines representing allowable paths and sequences of questions through the survey.

18. A computer-implemented method according to claim 1, wherein said sequence includes a single path flow, several paths or branches, or a combination of both.

19. A computer-implemented method according to claim 18, wherein the sequences run in parallel or are recursive and are marked by a start and end of a process.

20. A computer system that assists users to construct an on-line survey including a processor executing computer instruction code to:
present a graphical interface to the user that includes graphical objects representing pre-established survey components, the graphical objects representing question types and/or formats;
enable the user to select graphical objects and to place the graphical objects representing pre-established survey components in a sequence, thereby defining a sequence of steps in an on-line survey; and
display the sequence of graphical objects to the user on the graphical interface.
